(19) United States
(12) Patent Application Publication
(10) Pub. No.: US 2021/0130632 A1
(43) Pub. Date: May 6, 2021

(54) INK FOR PRODUCING SHAPED ARTICLE, SHAPED ARTICLE, AND THREE-DIMENSIONAL SHAPING APPARATUS

(71) Applicant: FUJI XEROX CO., LTD., Tokyo (JP)

(72) Inventors: Yasuo YAMAMOTO, Kanagawa (JP); Mieko SEKI, Kanagawa (JP); Takashi KIKUCHI, Kanagawa (JP); Takashi OYANAGI, Kanagawa (JP)

(73) Assignee: FUJI XEROX CO., LTD., Tokyo (JP)

(21) Appl. No.: 16/899,567

(22) Filed: Jun. 11, 2020

(30) Foreign Application Priority Data
Oct. 30, 2019 (JP) 2019-197481

(51) Int. Cl. C09D 11/38; C08J 9/12; B29C 64/106; C09D 11/107

(52) U.S. Cl. CPC C09D 11/38; C08J 9/12; B33Y 10/00; C09D 11/107; B29C 64/106

(57) ABSTRACT

An ink for producing a shaped article includes a photopolymerizable compound, and 5% by volume to 95% by volume of air bubbles relative to the total volume of the ink.

### CROSS-REFERENCE TO RELATED APPLICATIONS

This application is based on and claims priority under 35 USC 119 from Japanese Patent Application No. 2019-197481 filed Oct. 30, 2019.

### BACKGROUND

### (i) Technical Field

The present disclosure relates to an ink for producing a shaped article, a shaped article, and a three-dimensional shaping apparatus.

### (ii) Related Art

A three-dimensional shaping apparatus is also called a “3D printer”. An apparatus known as the three-dimensional shaping apparatus is, for example, one in which an ink for producing a shaped article is arranged according to the cross-sectional shape data of a three-dimensional shape by using an inkjet method or the like, and a three-dimensional shaped article (also simply referred to as a “shaped article” hereinafter) is produced by repeating curing with ultraviolet light or the like.

On the other hand, a resin structure containing air bubbles is expected to be applied to various usages. Also, a resin structure containing air bubbles is desired to be molded with good shape accuracy according to application.

For example, Japanese Unexamined Patent Application Publication (Translation of PCT Application) No. 2005-533874 discloses, as a composition for producing a resin molded product containing air bubble, an ultraviolet (UV)-curable and foamable resin composition containing (A) a photopolymerizable urethane acrylate oligomer, (B) a photopolymerizable monomer, (C) a photopolymerization initiator, (D) a photodecomposable foaming agent selected from a combination of an azo compound, a sulonium salt, and an inorganic carbonate and a mixture thereof, and (E) a photodecomposition catalyst.

Japanese Unexamined Patent Application Publication No. 2012-014163 describes, as a part of a method for producing a visibility improvement sheet, that a groove having a substantially rectangular sectional shape is filled with an ink composition containing a transparent ionizing radiation-curable resin composition and coloring fine particles, and in a state where air bubbles are randomly dispersed in the filled ink composition, the ink composition is cured.

### SUMMARY

Aspects of non-limiting embodiments of the present disclosure relate to an ink for producing a shaped article, which has high shape freedom of a producible air bubble-containing shaped article and which can easily produce an air bubble-containing shaped article having an intended shape with high accuracy as compared with an ink containing a photopolymerizable compound and a foaming agent.

Hereinafter, the “air bubble-containing shaped article” may be simply referred to as the “shaped article”.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an ink for producing a shaped article, which contains a photopolymerizable compound and 5% by volume or more and 95% by volume or less of air bubbles relative to the whole volume of the ink.

### BRIEF DESCRIPTION OF THE DRAWINGS

Exemplary embodiments of the present disclosure will be described in detail based on the following figures, wherein:

FIG. 1 is a schematic configuration diagram showing an example of a three-dimensional shaping apparatus according to an exemplary embodiment of the present disclosure;

FIG. 2 is a process drawing showing an example of a method for producing a three-dimensional shaped article according to an exemplary embodiment of the present disclosure;

FIG. 3 is a process drawing showing an example of a method for producing a three-dimensional shaped article according to an exemplary embodiment of the present disclosure;

FIG. 4 is a process drawing showing an example of a method for producing a three-dimensional shaped article according to an exemplary embodiment of the present disclosure; and

FIG. 5 is a schematic sectional view showing an example of the presence of air bubbles according to an exemplary embodiment of the present disclosure.

### DETAILED DESCRIPTION

Exemplary embodiments of the present disclosure are described below.

In addition, members having substantially the same function are denoted by the same reference numeral throughout all drawings, and duplicated description may be suitably omitted.

In the present specification, the term “(meth)acryl” is used as a concept including both “acryl” and “methacryl”, and the term “(meth)acrylate” is used as a concept including both “acrylate” and “methacrylate”.

Also, in the present specification, the term “oligomer” represents a polymer having a structural unit derived from a monomer, the polymer having a polymerizable group in its molecule and a weight-average molecular weight of 500 or more and 50,000 or less (preferably 500 or more and 40,000 or less).

### <Ink for Producing Shaped Article>

An ink for producing a shaped article (may be simply referred to as an “ink” hereinafter) according to an exemplary embodiment of the present disclosure contains a photopolymerizable compound and has 5% by volume or more and 95% by volume or less of air bubbles relative to the whole volume of the ink.

In general, an ink containing a photopolymerizable compound may inevitably contain less than 5% of air bubbles relative to the whole volume of the ink during production. However, the ink according to the exemplary embodiment of the present disclosure has 5% or more of air bubbles relative to the total volume of the ink and thus does not correspond to an ink containing air bubbles inevitably mixed therein.

A resin molded product containing air bubbles is generally produced by using a method of generating air bubbles in a resin molded product by, for example, using a foaming agent foamed by heat, a foaming agent foamed by chemical reaction, or the like.

This method has the problem of difficulty in producing a resin molded product having an intended shape because the resin molded product is expanded by foaming of the foaming agent. Although, in the method, an intended shape may be formed by cutting after air bubbles are generated in the resin molded product, it cannot be thought that the method has high freedom of shape and high accuracy for a complicated shape.

Therefore, the inventors have investigated an ink for producing a shaped article which has high freedom of shape for a producible air bubble-containing shaped article and which can easily produce an air bubble-containing shaped article having an intended shape with high accuracy, leading to the ink according to the exemplary embodiment of the present disclosure.

The ink according to the exemplary embodiment of the present disclosure is an ink containing a photopolymerizable compound and being cured by photopolymerization reaction.

The ink contains 5% by volume or more and 95% by volume or less of air bubbles relative to the total volume of the ink, thereby maintaining a state where the air bubbles are mixed in the resin molded product produced by curing the ink.

That is, an air bubble-containing shaped article in a state of containing air bubbles can be formed by curing the ink according to the exemplary embodiment of the present disclosure according to an intended shape. As a result, it is considered that a producible air bubble-containing shaped article having high shape freedom and an intended shape can be easily produced with high accuracy.

Details of the ink according to the exemplary embodiment are described below.

### [Air Bubbles]

The ink according to the exemplary embodiment of the present disclosure contains 5% by volume or more and 95% by volume or less of air bubbles relative to the total volume of the ink.

The ratio of air bubbles is also referred to as the “air bubble ratio”.

The air bubble ratio of the ink according to the exemplary embodiment of the present disclosure may be determined according to an intended air bubble-containing shaped article.

For example, when the air bubble-containing shaped article having a shock absorption rate of 70% or more and 90% or less is produced, the air bubble ratio is preferably 5% or more and 95% or less, more preferably 10% or more and 95% or less, and still more preferably 15% or more and 95% or less.

Similarly, when the air bubble-containing shaped article having an Asker C hardness of 10 degrees or more and 100 decrees or less is produced, the air bubble ratio is preferably 5% or more and 95% or less, more preferably 5% or more and 90% or less, and still more preferably 10% or more and 90% or less.

Also, the state of air bubbles in the resultant air bubble-containing shaped article can be controlled by the air bubble ratio of the ink.

For example, when the air bubbles in the air bubble-containing shaped article are caused to take a closed cell structure, the air bubble ratio is preferably 5% or more and 50% or less, more preferably 5% or more and 45% or less, and still more preferably 5% or more and 40% or less.

While when the air bubbles in the air bubble-containing shaped article are caused to have an open cell structure, the air bubble ratio is preferably 60% or more and 95% or less, more preferably 65% or more and 95% or less, and still more preferably 70% or more and 95% or less.

Herein, the “closed cell structure” represents a structure containing many independent air bubbles all surrounded by a wall surface (that is, a solid phase part of a shaped article) with an independent air bubble ratio of 80% or more. On the other hand, the open cell structure represents a structure containing open air bubbles (also referred to as “continuous air bubbles”) and having an independent air bubble ratio of less than 20%.

The dimeter of air bubbles in the ink according to the exemplary embodiment of the present disclosure may be determined according to the intended air bubble-containing shaped article.

From the viewpoint of easy control of the diameter, the number-average diameter of air bubbles in the ink according to the exemplary embodiment of the present disclosure is, for example, preferably 0.01 μm or more and 200 μm or less.

Also, from the viewpoint of producing the air bubble-containing shaped article having a shock absorption rate of 70% or more and 95% or less and producing the air bubble-containing shaped article having an Asker C hardness of 10 degrees or more and 100 degrees or less, the number-average diameter of air bubbles is preferably 1 μm or more and 200 μm or less and more preferably 10 μm or less and 150 μm or less.

Also, the state of air bubbles in the resultant air bubble-containing shaped article can be controlled by the diameter of air bubbles in the ink.

For example, when the air bubbles in the air bubble-containing shaped article are caused to have a closed cell structure, the number-average diameter of air bubbles in the ink is preferably 0.01 μm or more and 50 μm or less, more preferably 0.01 μm or less and 40 μm or less, and still more preferably 0.01 μm or more and 30 μm or less.

While, when the air bubbles in the air bubble-containing shaped article are caused to have an open cell structure, the number-average diameter of air bubbles in the ink is preferably 50 μm or more and 200 μm or less, more preferably 80 μm or more and 200 μm or less, and still more preferably 100 μm or more and 200 μm or less.

The air bubble ratio and the number-average diameter of air bubbles in the ink according to the exemplary embodiment of the present disclosure can be measured as follows.

That is, 7 g of the ink according to the exemplary embodiment of the present disclosure is poured into a container surrounded by a frame material composed of a silicone resin, irradiated with UV for 5 minutes by using a high-pressure mercury lamp with an output of 1500 W to form a sheet-like measurement sample of 15 mm×15 mm×5 mm (thickness).

The resultant measurement sample is cut in the thickness direction, and the air bubble size and area are analyzed by image analysis of a sectional image using a reflection electron microscope (SEM: SU3800, Hitachi High Technologies Corporation). The image analysis is performed by using particle size distribution measurement software Mac-View (Mountech Co. Ltd.).

The air bubble ratio is determined by (total area of air bubbles in the sectional image analyzed/total area of the sectional image analyzed×100).

The number-average diameter of air bubbles is determined from the equivalent circle diameters of ten air bubbles in the sectional image analyzed.

In the present disclosure, the values calculated from a section of the measurement sample as described above are referred to as the air bubble ratio and number-average diameter of air bubbles in the ink according to the exemplary embodiment of the present disclosure.

A method for obtaining the air bubble ratio in the ink according to the exemplary embodiment of the present disclosure is, for example, a method of mixing air bubbles in a liquid containing a photopolymerizable compound by using an air bubble generating device. By using the air bubble generating device, the air bubble ratio and air bubble diameter can be easily controlled.

Also, a method for mixing air bubbles in the ink according to the exemplary embodiment of the present disclosure may use air bubble-containing fine particles (air bubble-containing capsule particles).

The air bubble generating derive is not particularly limited and an air bubble generating device capable of generating air bubbles with an intended size may be used.

The air bubble ratio and air bubble diameter in the ink can be adjusted by properly changing the conditions for the air bubble generating derive, conditions for mixing air bubbles in the liquid containing the photopolymerizable compound, the composition of the liquid containing the photopolymerizable compound, or the like.

Usable examples of the air bubble generating device include a nanobubble-microbubble generating derive of Living Energies & Co., a high-speed mini-kit, a bubbling kit, or the like using SPG membrane emulsification (also referred to as “direct membrane emulsification method”) by a SPG membrane of SPG Techno Co. Ltd., a microchannel emulsification device of EP Tech Co., Ltd., and the like.

The gas contained in air bubbles in the ink according to the exemplary embodiment of the present disclosure is not particularly limited. For example, the gas contained in the air bubbles may be air, oxygen, carbon dioxide, or the like or inert gas.

Oxygen and carbon dioxide may be incorporated in a polymer (that is, the shaped article) of the photopolymerizable compound or may oxidize the polymer. When oxygen and carbon dioxide are incorporated in the polymer (shaped article) of the photopolymerizable compound, the shape of the shaped article may be changed with time. Further, oxygen and air containing oxygen may decrease the reactivity (that is, curability) of the ink according to the exemplary embodiment of the present disclosure. Thus, the gas contained in air bubbles in the ink according to the exemplary embodiment of the present disclosure is preferably inert gas such as nitrogen, helium, argon, or the like.

### [Photopolymerizable Compound]

The ink according to the exemplary embodiment of the present disclosure contains the photopolymerizable compound.

The photopolymerizable compound represents a compound having a photopolymerizable group. The photopolymerizable group is not particularly limited but is preferably an oligomer having two radical polymerizable groups in its molecule, and the photopolymerizable group is preferably a radical polymerizable group and is particularly preferably an ethylenically unsaturated group.

The ethylenically unsaturated group is particularly preferably a (meth)acryloyl group.

Specifically, the photopolymerizable compound is a monomer, an oligomer, a polymer, or the like, which has a photopolymerizable group.

In particular, from the viewpoint of producing a soft shaped article, the photopolymerizable compound is, for example, preferably a combination of a monomer and an oligomer, preferably a combination of a monofunctional monomer and a polyfunctional oligomer, and particularly preferably a combination of two types of polyfunctional monomers and a polyfunctional oligomer.

The content of the photopolymerizable compound relative to the total mass of the ink is preferably 80% by mass or more and 99% by mass or less, more preferably 85% by mass or more and 99% by mass or less, and still more preferably 90% by mass or more and 98% by mass or less.

### [Preferred Aspect]

The ink according to the exemplary embodiment of the present disclosure is described with respect to an ink (also referred to as a “specific ink” hereinafter) in a preferred aspect for producing a soft shaped article.

The specific ink contains, as the photopolymerizable compound, a monofunctional monomer A, a monofunctional monomer B, and a difunctional oligomer C. When the content of the monofunctional monomer A is W_{A} (parts by mass), the content of the monofunctional monomer B is W_{E} (parts by mass), and the content of the difunctional oligomer C is W_{C} (parts by mass), the specific ink preferably satisfies condition 1 and condition 2 below, and when the glass transition temperature of a homopolymer of the monofunctional monomer A is Tg_{A} (° C.) and the glass transition temperature of a homopolymer of the monofunctional monomer B is Tg_{B} (° C.), the specific ink preferably satisfies condition 3 and condition 4 below.

Condition 1: The ratio of (W_{A}+W_{B} W_{C}) to the total mass of the ink is 80%, by mass or more.

Condition 2: W_{C}/(W_{A}+W_{B} W_{C})×100 is 1% by mass or more and 10% by mass or less.

Condition 3: Tg_{A}−Tg_{B} is 100° C. or more.

Condition 4: (Tg_{A}×W_{A})/(W_{A}+W_{B})+(Tg_{B}×W_{B})/(W_{A}+W_{B}) is 40° C. or more and 60° C. or less.

### (Monofunctional Monomer a and Monofunctional Monomer B)

The specific ink preferably contains the monofunctional monomer A and the monofunctional monomer B.

Any monomers can be used as the monofunctional monomer A and the monofunctional monomer B and not particularly limited as long as the monomer contains one photopolymerizable group in its molecule.

A combination of two types of monomers having the glass transition temperatures satisfying the condition 3 is preferably selected as a combination of the monofunctional monomer A and the monofunctional monomer B in the specific ink.

The glass transition temperature of a homopolymer of a monofunctional monomer is determined by differential scanning calorimetry (that is, DSC).

First, a homopolymer is produced as follows.

A monomer is mixed with azodiisobutyronitrile (also referred to as “AIBN”) used as a photopolymerization initiator and toluene used as a solvent at a ratio of monomer/AIBN/toluene=1/0.01/10 (ratio by mass), and polymerization reaction is performed at 65° C. for 8 hours in a nitrogen atmosphere. After the completion of reaction, the reaction product is cooled, purified by reprecipitation with a poor solvent such as ethanol or the like, and then dried under reduced pressure at 60° C. for 8 hours, producing a homopolymer.

The glass transition temperature of the resultant homopolymer is determined from a DSC curve obtained by differential scanning calorimetry (that is, DSC). More specifically, the glass transition temperature is determined, from the obtained DSC curve, as the “extrapolated glass transition initiation temperature” described in “Determination of glass transition temperature” of JIS K-2120: 1987 “Testing Methods for Transition Temperatures of Plastics”.

When a commercial product is used as a monofunctional monomer, the value of glass transition temperature (Tg) described in a catalogue or the like describing commercial products may be used.

As described above, the photopolymerizable group possessed by the monofunctional monomer A and the monofunctional monomer B is particularly preferably a (meth)acryloyl group.

That is, either of the monofunctional monomer A and the monofunctional monomer B is particularly preferably a (meth)acrylate compound (also referred to as a “monofunctional (meth)acrylate compound” hereinafter) having one (meth)acryloyl group in its molecule.

### —Monofunctional (Meth)Acrylate Compound—

The structure of the monofunctional (meth)acrylate compound is not limited, but from the viewpoint of easy availability and preparation cost, for example, an alkyl (meth)acrylate having a chain, branched, or cyclic alkyl group may be used. The alkyl group possessed by alkyl (meth)acrylate may be either unsubstituted or substituted.

In addition, a substituent which can be introduced into an alkyl group possessed by the alkyl (meth)acrylate is not particularly limited, but is preferably a substituent containing an oxygen atom. Examples thereof include an ethyleneoxy group, a propyleneoxy group, a phenoxy group, a carbamoyloxy group, an ester group (—C(═O)O—R), a heterocyclic group containing an oxygen atom (for example, a group produced by removing a hydrogen atom from a dioxane ring), a group produced by removing a hydrogen atom from a dioxolane ring, a group produced by removing a hydrogen atom from a tetrahydrofuran ring, and the like), and the like.

The substituent may have further a substituent, and examples of the substituent include an alkyl group, an ethyleneoxy group, a propyleneoxy group, and the like.

Examples of the alkyl (meth)acrylate having an unsubstituted alkyl group include methyl (meth)acrylate, ethyl (meth)acrylate, isobutyl (meth)acrylate, tert-butyl (meth)acrylate, lauryl (meth)acrylate, stearyl (meth)acrylate, isostearyl (meth)acrylate, cyclohexyl (meth)acrylate, 4-tert-cyclohexyl (meth)acrylate, isobornyl (meth)acrylate, dicyclopentanyl (meth)acrylate, dicycicopentenyl (meth)acrylate, benzyl (meth)acrylate, isoamyl (meth)acrylate, and the like.

Examples of the alkyl (meth)acrylate having a substituted alkyl group include phenoxyethyl (meth)acrylate, phenoxydiethylene glycol (meth)acrylate, m-phenoxybenzyl (meth)acrylate, 2-(N-butylcarbamoyloxy)ethyl (meth)acrylate, 2-(2-ethoxyethoxy)ethyl (meth)acrylate, 2-ethylhexyl EO (ethylene oxide)-modified (meth)acrylate, 2-methyl-2-ethyl-1,3-dioxolan-4-yl)methyl acrylate, cyclic trimethylolpropane formal acrylate, ethoxyethoxyethanol acrylic acid multimer ester, tetrahydrofurfuryl (meth)acrylate, tetrahydrofurfuryl alcohol acrylic acid multimer ester, phenoxypolyethylene glycol (meth)acrylate, methoxypolyethylene glycol (meth)acrylate, ethoxydiethylene glycol (meth)acrylate, and the like.

Among these, from the viewpoint of easily satisfying the condition 3 and easily producing a shaped article having excellent shock absorption and being hardly deformed, a homopolymer of the monofunctional monomer A preferably has a glass transition temperature Tg_{A} of 90° C. or more and more preferably 100° C. or more. The upper limit of the glass transition temperature Tg_{A} may be determined to satisfy the condition 4 and is, for example, 150° C. or less.

The monofunctional monomer A is preferably at least one selected from the group consisting of dicyclopentanyl (meth)acrylate, dicyclopentenyl (meth)acrylate, and isobornyl (meth)acrylate.

Also, from the viewpoint of easily satisfying the condition 3 and easily producing a shaped article having excellent shock absorption and being hardly deformed, a homopolymer of the monofunctional monomer B preferably has a glass transition temperature Tg_{B} of −10° C. or less. The lower limit of the glass transition temperature Tg_{B} may be determined to satisfy the condition 4 and is, for example, 75° C. or more.

The monofunctional monomer b is preferably at least one selected from the group consisting of phenoxydiethylene glycol (meth)acrylate, (2-methyl-2-ethyl-1,3-dioxolan-4-yl)methyl acrylate, tetrahydrofurfuryl (meth)acrylate, phenoxyethyl (meth)acrylate, tetrahydrofurfuryl alcohol acrylic acid multimer ester, phenoxyethyl (meth)acrylate, phenoxypolyethylene glycol (meth)acrylate, methoxypolyethylene glycol (meth)acrylate, isoamyl (meth)acrylate, and ethoxydiethylene glycol (meth)acrylate.

The monofunctional monomer B is particularly preferably at least one selected from the group consisting of phenoxydiethylene glycol (meth)acrylate, (2-methyl-2-ethyl-1,3-dioxolan-4-yl)methyl acrylate, tetrahydrofurfuryl (meth)acrylate, and phenoxyethyl (meth)acrylate.

The contents (that is, the content W_{A} of the monofunctional monomer A and the content W_{B} of the monofunctional monomer B) of the monofunctional monomer A and the monofunctional monomer B contained in the specific ink may be determined to satisfy the condition 4 based on the respective glass transition temperatures (that is, Tg_{A} and Tg_{B}).

The condition 4 “(Tg_{A}×W_{A})/(W_{A}+W_{B})+(Tg_{B}×W_{B})/(W_{A}+W_{B})” is preferably 42° C. or more and 58° C. or less.

The content W_{A} of the monofunctional monomer A and the content W_{B} of the monofunctional monomer B preferably satisfy at least one of condition 5 and condition 6 below and more preferably satisfy both the conditions.

Condition 5: W_{A}/(W_{A}+W_{B} W_{C})×100 is 36% by mass or more and 60% by mass or less.

Condition 6: W_{B}/(W_{A}+W_{E} W_{C})×100 is 36% by mass or more and 60% by mass or less.

The condition 5 “W_{A}/(W_{A}+W_{E} W_{C})×100” is more preferably 40% by mass or more and 55% by mass or less and still more preferably 40% by mass or more and 50% by mass or less.

The condition 6 “W_{B}/(W_{A}+W_{E} W_{C})×100” is more preferably 40% by mass or more and 55% by mass or less and still more preferably 40% by mass or more and 50% by mass or less.

The content W_{A} of the monofunctional monomer A and the content W_{B} of the monofunctional monomer B preferably satisfy condition 7 below.

Condition 7: W_{A}:W_{B} is 40:60 to 60:40.

The condition 7 “W_{A}:W_{B}” is more preferably 45:55 to 55:45.

The total (that is, W_{A} W_{B}) of the content W_{A} of the monofunctional monomer A and the content W_{B} of the monofunctional monomer B is 90% by mass or more and 99% by mass or less, preferably 90% by mass or more and 95% by mass or less, and still more preferably 90% by mass or more and 93% by mass or less relative to the total (that is, W_{A}+W_{E}+W_{C}) of the content W_{A} of the monofunctional monomer A, the content W_{E} of the monofunctional monomer B, and the content W_{C} of the difunctional oligomer C.

### (Difunctional Oligomer C)

The specific ink preferably contains the difunctional oligomer C.

The difunctional oligomer C is an oligomer having two photopolymerizable groups in its molecule, and as described above, the photopolymerizable group is particularly preferably a (meth)acryloyl group.

That is, the difunctional oligomer C is particularly preferably a (meth)acrylate oligomer having two (meth)acryloyl groups in its molecule.

Examples of the difunctional oligomer C include a urethane (meth)acrylate oligomer, a polybutadiene (meth)acrylate oligomer, an epoxy (meth)acrylate oligomer, polyester (meth)acrylate oligomer, a polyether (meth)acrylate oligomer, and the like.

Among these, from the viewpoint of compatibility and reactivity with other components, the difunctional oligomer C is particularly preferably a difunctional urethane (meth)acrylate oligomer.

### —Difunctional Urethane (Meth)Acrylate Oligomer—

The difunctional urethane (meth)acrylate oligomer has a urethane bond and two (meth)acryloyl groups in its molecule.

More specifically, the urethane (meth)acrylate oligomer is a monomer having a configuration unit, containing a urethane bond “—NHC(═O)O—” or “—OC(═O)NH—”, and two (meth)acryloyl groups in its molecule.

From the viewpoint of easy adjustment of hardness and excellent mechanical strength, heat resistance, abrasion resistance, chemical resistance, and the like, the urethane (meth)acrylate oligomer is preferably polyether urethane acrylate oligomer or polyester urethane acrylate oligomer.

The urethane (meth)acrylate oligomer is, for example, a reaction product obtained by using a polyisocyanate compound, a polyol compound, and (meth)acrylate having a hydroxyl group.

Specifically, the urethane (meth)acrylate oligomer is, for example, a reaction product of a prepolymer produced by reacting a polyisocyanate compound with a polyol compound and having an isocyanate group at an end and a (meth)acrylate having a hydroxyl group.

The components for producing the urethane (meth)acrylate oligomer are described below.

### Polyisocyanate Compound

Examples of the polyisocyanate compound include a chain saturated hydrocarbon isocyanate, a cyclic saturated hydrocarbon isocyanate, an aromatic polyisocyanate, and the like.

Examples of the chain saturated hydrocarbon isocyanate include tetramethylene diisocyanate, hexamethylene diisocyanate, 2,2,4-trimethylhexamethylene diisocyanate, 2,4,4-trimethylhexamethylene diisocyanate, and the like.

Examples of the cyclic saturated hydrocarbon isocyanate include isophorone diisocyanate, norbornane diisocyanate, dicyclohexylmethane diisocyanate, methylene bis(4-cyclohexylisocyanate), hydrogenated diphenylmethane diisocyanate, hydrogenated xylene diisocyanate, hydrogenated toluene diisocyanate, and the like.

Examples of the aromatic polyisocyanate include 2,4-tolylene diisocyanate, 1,3-xylylene diisocyanate, p-phenylene diisocyanate, 3,3′-dimethyl-4,4′-diisocyanate, 6-isopropyl-1,3-phenyl diisocyanate, 1,5-naphthalene diisocyanate, and the like.

### Polyol Compound

Examples of the polyol compound include polyhydric alcohols such as diol and the like.

Examples of the diol include alkylene glycols (for example, ethylene glycol, 1,2-propanediol, 1,3-propanediol, 2-methyl-1,3-propanediol, 1,3-butanediol, 1,4-butanediol, 1,5-pentanediol, 2-methyl-1,5-pentanediol, neopentyl glycol, 3-methyl-1,5-pentanediol, 2,3,5-trimethyl-1,5-pentanediol, 1,6-hexanediol, 2-ethyl-1,6-hexanediol, 2,2,4-trimethyl-1,6-hexanediol, 1,8-octanediol, 1,9-nonanediol, 1,10-decanediol, 1,12-dodecanediol, 1,14-tetradecanediol, 1,16-hexadecanediol, 1,2-dimethylolcyclohexane, 1,3-dimethylolcyclohexane, 1,4-dimethylolcyclohexane, and the like), and the like.

Examples of the polyhydric alcohols other than diol include alkylene polyhydric alcohols having three or more hydroxyl groups (for example, glycerin, trimethylolethane, trimethylolpropane, 1,2,6-hexanetriol, 1,2,4-butanetriol, erythritol, sorbitol, pentaerythritol, dipentaerythritol, mannitol, and the like.

Other examples of the polyol compound include polyether polyol, polyester polyol, polycarbonate polyol, and the like.

Examples of the polyether polyol include a polyhydric alcohol multimer, a polyhydric alcohol alkylene oxide adduct, an alkylene oxide ring-opened polymer, and the like.

In this case, examples of the polyhydric alcohol include ethylene glycol, diethylene glycol, propylene glycol, dipropylene glycol, 1,4-butanediol, 1,3-butanediol, neopentyl glycol, 1,6-hexanediol, 1,2-hexanediol, 3-methyl-1,5-pentanediol, 2-butyl-2-ethyl-1,3-propanediol, 2,4-diethyl-1,5-pentanediol, 1,8-octanediol, 1,9-nonanediol, 2-methyl-1,8-octanediol, 1,8-decanediol, octadecanediol, glycerin, trimethylolpropane, pentaerythritol, hexanetriol, and the like.

Examples of the alkylene oxide include ethylene oxide, propylene oxide, butylene oxide, styrene oxide, epichlorohydrin, tetrahydrofuran, and the like.

Examples of the polyester polyol include a reaction product of a polyhydric alcohol and a dibasic acid, a cyclic ester compound ring-opened polymer, and the like.

In this case, examples of the polyhydric alcohol include the same examples of polyhydric alcohols described for the polyether polyol.

Examples of the dibasic acid include carboxylic acids (for example, succinic acid, adipic acid, sebacic acid, dimer acid, maleic acid, phthalic acid, isophthalic acid, terephthalic acid, and the like), carboxylic acid anhydrides and the like.

Examples of the cyclic ester compound include ε-caprolactone, β-methyl-δ-valerolactone, and the like.

Examples of the polycarbonate polyol include the reaction product of glycol and alkylene carbonate, the reaction product of glycol and diaryl carbonate, the reaction product of glycol and dialkyl carbonate, and the like.

In this case, examples of the alkylene carbonate include ethylene carbonate, 1,2-propylene carbonate, 1,2-butylene carbonate, and the like. Examples of the diaryl carbonate include diphenyl carbonate, 4-methyldiphenyl carbonate, 4-ethyldiphenyl carbonate, 4-propylenediphenyl carbonate, 4,4′-dimethyldiphenyl carbonate, 2-tolyl-4-tolyl carbonate, 4,4′-diethyldiphenyl carbonate, 4,4′-dipropyldiphenyl carbonate, phenyltoluyl carbonate, bischlorophenyl carbonate, phenylchlorophenyl carbonate, phenylnaphthyl carbonate, dinaphthyl carbonate, and the like.

Examples of the dialkyl carbonate include dimethyl carbonate, diethyl carbonate, di-n-propyl carbonate, diisopropyl carbonate, di-n-butyl carbonate, diisobutyl carbonate, di-tert-butyl carbonate, di-n-amyl carbonate, diisoamyl carbonate, and the like.

### Hydroxyl Group-Containing (Meth)Acrylate

Examples of the hydroxyl group-containing (meth)acrylate include 2-hydroxyethyl (meth)acrylate, 2-hydroxypropyl (meth)acrylate, 2-hydroxybutyl (meth)acrylate, 2-hydroxy-3-phenoxypropyl (meth)acrylate, glycerin di(meth)acrylate, trimethylolpropane di(meth)acrylate, pentaerythritol tri(meth)acrylate, dipentaerythritol penta(meth)acrylate, and the like.

Other examples of the hydroxyl group-containing (meth)acrylate include (meth)acrylic acid adducts of glycidyl group-containing compounds (for example, alkyl glycidyl ether, ally glycidyl ether, glycidyl (meth)acrylate, and the like).

### —Weight-Average Molecular Weight of Urethane (Meth)Acrylate Oligomer—

The weight-average molecular weight of the urethane (meth)acrylate oligomer is preferably 500 or more and 50,000 or less and more preferably 1,000 or more and 40,000 or less, and the upper limit is more preferably 35,000 or less.

The weight-average molecular weight of the urethane (meth)acrylate oligomer is a value measured by gel permeation chromatography (GPC) using polystyrene standard substances.

The difunctional oligomers C may be used alone or in combination of two or more.

The content W_{C} of the difunctional oligomer C in the specific ink satisfies the condition 2 described above.

That is, the content W_{C} of the difunctional oligomer C relative to the total of the content W_{A} of the monofunctional monomer A, the content W_{B} of the monofunctional monomer B, and the content W_{C} of the difunctional oligomer C is 1% by mass or more and 10% by mass or less, preferably 5% by mass or more and 10% by mass or less, and more preferably 7% by mass or more and 10% by mass or less.

### (Other Components)

The specific ink may contain, as other components, components other than the monofunctional monomer A, the monofunctional monomer B, and the difunctional oligomer C described above.

Examples of the other components include other polymerizable compounds, a photopolymerization initiator, an oxygen scavenger, a polymerization inhibitor, a surfactant, a granular material, other additives, and the like.

The total of the other components in the specific ink relative to the total mass of the ink is preferably 20% by mass or less and more preferably 10% by mass or less.

### —Other Polymerizable Compound—

The specific ink may further contain a polymerizable compound (also referred to as the “other polymerizable compound”) other than the monofunctional monomer A, the monofunctional monomer B, and the difunctional oligomer C within a range which does not impair the effect of producing the shaped article having excellent shock absorption and being hardly deformed.

Examples of the polymerizable compound include monomers (including a monofunctional monomer and a polyfunctional monomer) other than the monofunctional monomer A and the monofunctional monomer B, a monofunctional oligomer, a tri- or higher-functional oligomer, a polymer having a polymerizable group, and the like.

A photopolymerizable slide-ring polymer can also be used as the other polymerizable compound.

The slide-ring polymer is a composite having plural cyclic molecules and a linear molecule in a state where the plural cyclic molecules are skewered, and an example thereof is polyrotaxane. The photopolymerizable slide-ring polymer is the composite (for example, polyrotaxane) having a photopolymerizable group (preferably a (meth)acryloyl group) in a side chain.

Use of the photopolymerizable slide-ring polymer creates a state where a portion of the crosslink structure in the resultant shaped article is not fixed. Consequently, a polymer compound (that is, the polymer) in the resultant air bubble-containing shaped article is easily moved against the external stress (for example, shock) received by the air bubble-containing shaped article, and thus the shock absorption can be considered to be improved without a significant increase in hardness of the air bubble-containing shaped article.

### —Photopolymerization Initiator—

The photopolymerization initiator is not limited as long as it contributes to the curing reaction of the oligomer and monomer described above and is preferably a photo-radical polymerization initiator.

Examples of the photo-radical polymerization initiator include, but are not particularly limited to, acetophenones, benzoins, benzophenones, phosphine oxides, ketals, anthraquinones, thioxanthones, azo compounds, peroxides, 2,3-alkyldione compounds, disulfide compounds, fluoroamine compounds, aromatic sulfoniums, and the like.

Examples of acetophenones include 2,2-ethoxyacetophenone, p-methylacetophenone, 1-hydroxydimethyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, and the like.

Examples of benzoins include benzoinbenzene sulfonate esters, benzointoluene sulfonate esters, benzoin methyl ether, benzoin ethyl ether, benzoin isopropyl ether, and the like.

Examples of benzophenones include benzophenone, 2,4-chlorobenzophenone, 4,4-dichlorobenzophenone, p-chlorobenzophenone, and the like.

Examples of phosphine oxides include 2,4,6-trimethylbenzoyl diphenylphosphine oxide (commercial product: IGM Resins, Inc., Omnirad TPO), bis(2,4,6-trimethylbenzoyl)-phenylphosphine oxide (also referred to as “BAPO”, commercial product: IGM Resins, Inc., Omnirad 819), and the like.

The photopolymerization initiators may be used alone or in combination of two or more.

The content of the photopolymerization initiator relative to the total mass of the ink is preferably 1% by mass or more and 10% by mass or less, more preferably 1% by mass or more and 8% by mass or less, and still more preferably 2% by mass or more and 6% by mass or less.

### (Oxygen Scavenger)

Examples of the oxygen scavenger include an amine-based oxygen scavenger, an organic phosphorus-based oxygen scavenger, and the like.

The amine-based oxygen scavenger is an oxygen scavenger having an amino group, and examples thereof include ethyl 4-(dimethylamino)benzoate and the like.

The organic phosphorus-based oxygen scavenger is an oxygen scavenger having a phosphorus atom, and examples thereof include triphenylphosphine (TPP), triethylphosphite (TEP), and the like.

Among these, from the viewpoint of safety, the amine-based oxygen scavenger is referred, and ethyl 4-(dimethylamino)benzoate is particularly preferred.

The oxygen scavengers may be used alone or in combination of two or more.

The content of the oxygen scavenger relative to the total mass of the ink is preferably 0.1% by mass or more and 0.5% by mass or less and more preferably 0.1% by mass or more and 0.4% by mass or less.

### (Polymerization Inhibitor)

Examples of the polymerization inhibitor include known polymerization inhibitors such as phenolic polymerization inhibitors (for example, p-methoxyphenol, cresol, tert-butylcatechol, 3,5-di-tert-butyl-4-hydroxytoluene, 2,2′-methylene bis(4-methyl-6-tert-butylphenol), 2,2′-methylene bis(4-ethyl-6-butylphenol), 4,4′-thiobis(3-methyl-6-tert-butylphenol, and the like), hindered amine, hydroquinone monomethyl ether (MEHQ), hydroquinone, and the like.

The polymerization inhibitors may be used alone or in combination of two or more.

The content of the polymerization inhibitor relative to the total mass of the ink is preferably 0.1% by mass or more and 1% by mass or less and more preferably 0.2% by mass or more and 0.6% by mass or less.

### (Surfactant)

Examples of the surfactant include known surfactants such as a silicone-based surfactant, an acrylic surfactant, a cationic surfactant, an anionic surfactant, a nonionic surfactant, an amphoteric surfactant, a fluorine-based surfactant, and the like.

In particular, a surfactant having a radical polymerizable group is preferred, and a silicone-based surfactant having a radial polymerizable group (for example, Evonik Corp., TEGO (registered trademark) RAD 2010 and TEGO (registered trademark) RAD 2011, and the like) is particularly preferred.

The surfactants may be used alone or in combination of two or more. The content of the surfactant in the ink relative to the total mass of the ink is preferably 0.1% by mass or more and 0.5% by mass or less and more preferably 0.1% by mass or more and 0.4% by mass or less.

### (Granular Material)

From the viewpoint of enhancing the strength of the shaped article, the specific ink may contain the granular material.

The granular material is not particularly limited as long as an attempt can be made to reinforce the strength of the ink, and either an inorganic granular material or an organic granular material may be used.

Examples of the granular material include silicon dioxide particles which can reinforce the strength of the shaped article while imparting transparency; a black granular material of carbon black or the like, which can reinforce the strength of the shaped article while imparting a color; and a white granular material such as titanium oxide particles, aluminum oxide particles, and the like.

Other examples of the granular material which can reinforce the strength of the shaped article while imparting a color include a yellow pigment, a magenta pigment, a cyan pigment, and the like.

### (Other Additives)

Examples of other additives include known additives such as a coloring agent, a solvent, a sensitizer, a fixing agent, an anti-mold agent, an antiseptic agent, an antioxidant, an ultraviolet absorber, a chelating agent, a thickener, a dispersant, a polymerization accelerator, a penetration accelerator, a wetting agent (moisturizing agent), and the like.

### [Characteristics of Ink]

### Viscosity

From the viewpoint of retention of air bubbles in the ink, applicability to a three-dimensional shaping apparatus, etc., the viscosity of the ink at 25° C. is preferably 1 mPa·s or more and 10,000 mPa·s or less, more preferably 10 mPa·s or more and 1,000 mPa·s or less, and still more preferably 10 mPa·s or more and 500 mPa·s or less.

The viscosity is measured by using TVE-25L manufactured by Toki Sangyo Co., Ltd. as a measuring device under the conditions including a measurement temperature of 25° C. and a shear rate of 200 (1/s).

### Surface Tension

The surface tension of the ink is, for example, preferably within a range of 20 mN/m or more and 35 mN/m or less and more preferably within a range of 24 mN/m or more and 30 mN/m or less.

The surface tension is a value measured by using a Wilhelmy surface tension meter (manufactured by Kyowa Interface Science Co., Ltd.) in an environment of 23° C. and 55% RH.

### <Method for Producing Three-Dimensional Shaped Article and Three-Dimensional Shaping Apparatus>

A method for producing the three-dimensional shaped article according to the exemplary embodiment of the present disclosure includes ejecting the ink and irradiating the ejected ink with light to cure the ink. The ink according to the exemplary embodiment described above can be applied as the ink to be ejected.

The method for producing a three-dimensional shaped article according to the exemplary embodiment is performed to produce a three-dimensional shaped article by using a three-dimensional shaping apparatus according to an exemplary embodiment of the present disclosure.

That is, the three-dimensional shaping apparatus according to the exemplary embodiment is a three-dimensional shaping apparatus including an ejection part which houses the ink according to the exemplary embodiment of the present disclosure and ejects the ink, and a light irradiating part which irradiates the ink ejected from the ejection part with light to cure the ink.

The three-dimensional shaping apparatus may include an ink cartridge which houses the ink and is made into a cartridge detachable from the three-dimensional shaping apparatus.

The three-dimensional shaping apparatus may include a first ejection part which contains the ink and ejects the ink, a second ejection part which contains a support material and ejects the support material, and a light irradiating part which irradiates the ejected ink and support material with curing light.

The three-dimensional shaping apparatus including the first ejection part, the second ejection part, and the light irradiating part may include, in addition to the ink cartridge, a support material cartridge which contains the support material and is made into a cartridge detachable from the three-dimensional shaping apparatus.

In the three-dimensional shaping apparatus including the first ejection part, the second ejection part, and the light irradiating part, for example, a shaped article is formed by ejecting the ink and curing it by light irradiation, and a support part which supports at least a portion of the shaped article is formed by ejecting the support material and curing it by light irradiation. Then, after the shaped article formed, the support part is removed to produce the intended three-dimensional shaped article.

The three-dimensional shaping apparatus including the first ejection part, the second ejection part, and the light irradiating part is described below as an example of the three-dimensional shaping apparatus according to the exemplary embodiment of the present disclosure with reference to the drawings.

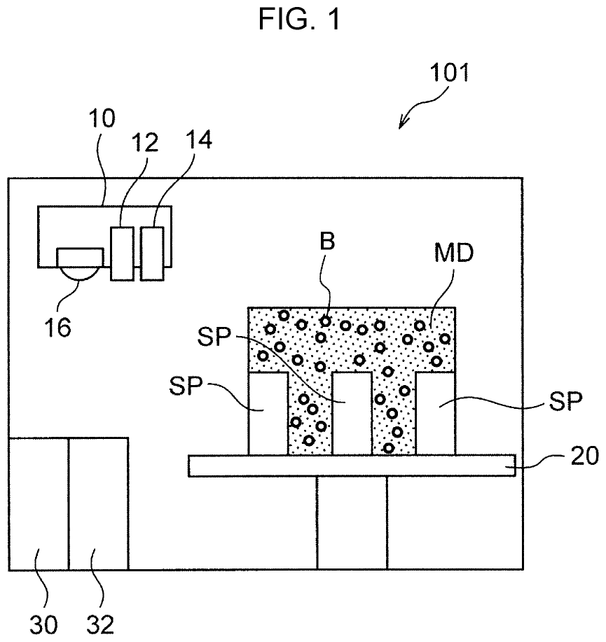

FIG. 1 is a schematic configuration diagram showing an example of the three-dimensional shaping apparatus including the first ejection part, the second ejection part, and the light irradiating part as the three-dimensional shaping apparatus according to the exemplary embodiment of the present disclosure.

A three-dimensional shaping apparatus 101 according to the exemplary embodiment is a three-dimensional shaping apparatus of an inkjet system. As shown in FIG. 1, the three-dimensional shaping apparatus 101 includes, for example, a shaping unit 10 and a shaping table 20. The three-dimensional shaping apparatus 101 also includes an ink cartridge 30 which houses the ink and a support material cartridge 32 which houses the support material, the cartridges 30 and 32 being detachable from the apparatus 101. In FIG. 1, MD denotes a shaped article, B denotes air bubbles in the shaped article, and SP denotes a support part.

The shaping unit 10 includes, for example, an ink ejection head 12 (an example of the first ejection part) which ejects droplets of the ink, a support material ejection head 14 (an example of the second ejection part) which ejects droplets of the support material, and a light irradiating device 16 which irradiates with light. In addition, although not shown in the drawings, the shaping unit 10 may further include, for example, a rotating roller which flattens the ink and support material ejected on the shaping table 20 by removing the excessive ink and support material.

The shaping unit 10 is of a type (so-called carriage type) in which, for example, it can be moved on a shaping region of the shaping table 20 in a main scanning direction and a sub-scanning direction crossing (for example, perpendicular to) the main scanning direction by a drive device (not shown).

An ejection head of a piezo system (piezoelectric system) which ejects, under pressure, droplets of each of the ink and the support material is applied as the ink ejection head 12 and the support material ejection head 14. Each of the ejection heads is not limited to this and may be an ejection head type in which each material is ejected by, for example, the pressure by a pump as long as the ink can be ejected or pushed out on the shaping table 20.

Also, each of the ejection heads may be properly determined according to the size of the shaping article produced, viscosity of the ink, etc., and any one of an inkjet system, an injector system, and a printing system may be used.

The ink ejection head 12 is connected to, for example, the ink cartridge 30 through a supply tube (not shown). The ink is supplied to the ink ejection head 12 from the ink cartridge 30.

The support material ejection head 14 is connected to, for example, the support material cartridge 32 through a supply tube (not shown). The support material is supplied to the support material ejection head 14 from the support material cartridge 32.

Each of the ink ejection head 12 and the support material ejection head 14 is a short ejection head in which an effective ejection region (a region where ejection nozzles of the ink and the support material are arranged) is smaller than the shaping region of the shaping table 20.

Each of the ink ejection head 12 and the support material ejection head 14 may be a long ejection head in which an effective ejection region (a region where ejection nozzles of the ink and the support material are arranged) is equal to or larger than the width of the shaping region of the shaping table 20 (the length in a direction crossing (for example, perpendicular to) the movement direction (main scanning direction) of the shaping unit 10). In this case, the shaping unit 10 is of a type in which it is moved only in the main scanning direction.

The light irradiating device 16 may be any device which irradiates light to cure the ink and the support material, and, for example, an ultraviolet irradiating device which irradiates ultraviolet light is used.

Examples of the ultraviolet irradiating device which can be applied include devices having light sources such as a metal halide lamp, a high-pressure mercury lamp, a super high-pressure mercury lamp, a deep ultraviolet lamp, a lamp using microwaves for exciting a mercury lamp from the outside without an electrode, an ultraviolet laser, a xenon lamp, UV-LED (ultraviolet light emitting diode), and the like. Among these, from the viewpoint of suppressing a temperature increase during production of a three-dimensional shaped article, an ultraviolet laser and UV-LED (ultraviolet light emitting diode) are preferred.

The shaping table 20 has a surface having the shaping region where the ink and the support material are ejected to form a shaped article. The shaping table 20 is moved up and down by a drive device (not shown).

Next, the operation (that is, the method for producing the three-dimensional shaped article) of the three-dimensional shaping apparatus 101 according to the exemplary embodiment is described.

First, two-dimensional shape data (slice data) for, for example, forming the shaped article is formed, by a computer or the like (not shown), as three-dimensional shaping data from, for example, three-dimensional CAD (Computer Aided Design) data of the three-dimensional shaped article to be shaped with the ink. In this case, two-dimensional shape data (slice data) for forming the support part by the support material is also formed. When there is a so-called overhanging portion where the width of the shaped article at an upper position is larger than the width of the shaped article at a lower position, the two-dimensional shape data for forming the support part is formed so as to form the support part which supports the overhanding portion from below.

Next, based on the two-dimensional shape data for forming the shaped article, the ink is ejected from the ink ejection head 12 while the shaping unit 10 is moved, thereby forming a layer of the ink on the shaping table 20. Then, the ink is cured by irradiating, with light, the layer of the ink by using the light irradiating device 16, thereby forming a layer as a portion of the shaped article.

If required, based on the two-dimensional shape data for forming the support part, the support material is ejected from the support material ejection head 14 while the shaping unit 10 is moved, thereby forming a layer of the support material adjacent to the layer of the ink on the shaping table 20. Then, the support material is cured by irradiating, with light, the layer of the support material by using the light irradiating device 16, thereby forming a layer as a portion of the support part.

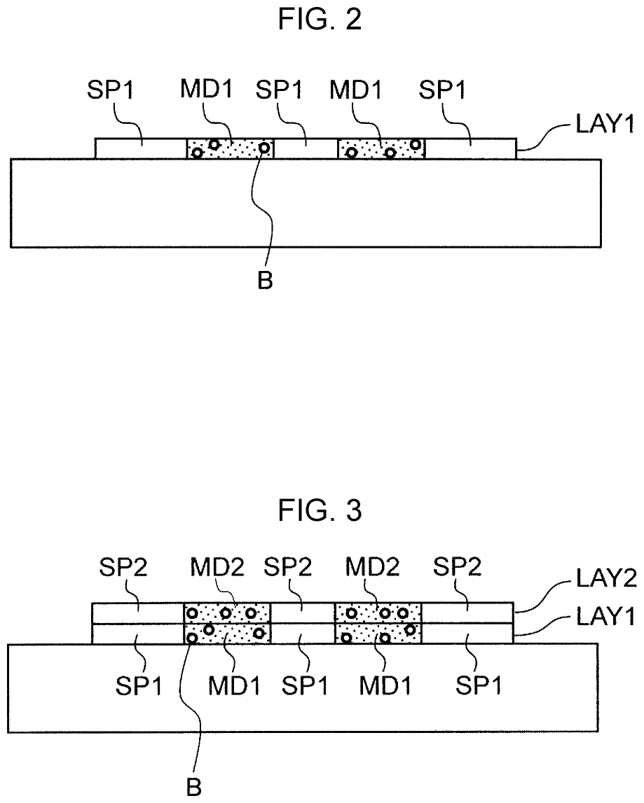

Therefore, a first layer LAY1 including the layer serving as a portion of the shaped article and, if required, the layer serving as a portion of the support part is formed (refer to FIG. 2). In FIG. 2, MD1 denotes the layer serving as a portion of the shaped article in the first layer LAY1, and SP1 denotes the layer serving as a portion of the support part in the first layer LAY1.

Next, the shaping table 20 is moved down. The shaping table 20 is moved down by an amount corresponding to the thickness of a second layer to be formed next (a second layer including a layer serving as a portion of the shaped article and, if required, a layer serving as a portion of the support layer).

Next, the second layer LAY2 including a layer serving as a portion of the shaped article and, if required, a layer serving as a portion of the support layer is formed in the same manner as the first layer LAY1 (refer to FIG. 3). In FIG. 3, MD2 denotes the layer serving as a portion of the shaped article in the second layer LAY2, and SP2 denotes the layer serving as a portion of the support part in the second layer LAY2.

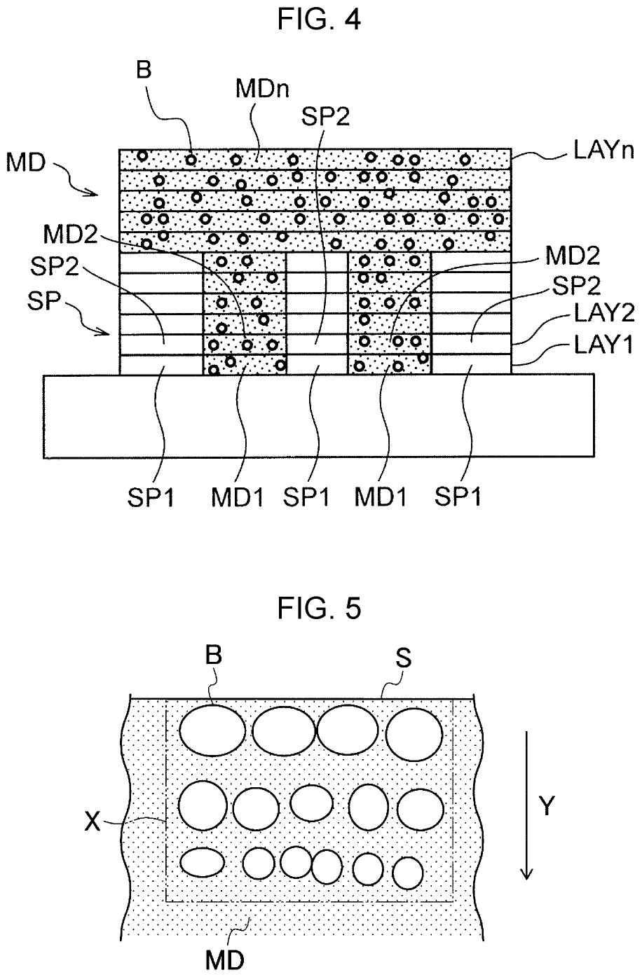

The operation of forming the first layer LAY1 and the second layer LAY2 is repeated to form up to an nth layer LAYn. Therefore, the shaped article at least partially supported by the support material is formed (refer to FIG. 4). In FIG. 4, MDn denotes the layer serving as a portion of the shaped article in the nth layer LAYn.

In FIG. 4, MD denotes the shaped article, B denotes air bubbles, and SP denotes the support part.

Then, the support part is removed from the shaped article, thereby producing an intended three-dimensional shaped article. The support part is preferably removed by, for example, using a hand-removal method (brake-away method), a method of removing by spraying gas, a removal method (immersion method) of dissolving the support part by immersing the three-dimensional shaped article having the support part in hot water, a method (spray method) of removing the support part by hydraulic pressure while dissolving the support part by spraying hot water on the three-dimensional shaped article having the support part, or the like. From the viewpoint of a simple removal method, the immersion method is more preferred for removal. The immersion method preferably also uses irradiation with ultrasonic waves.

The resultant three-dimensional shaped article may be post-treated by polishing or the like.

Plural types of inks may be used as the inks ejected for forming the layers such as the first layer, the second layer, the nth layer, etc. In the use of plural types of inks, from the viewpoint of enhancing adhesion at the interface between the shaped articles obtained with the respective inks, the inks ejected in the adjacent regions preferably have a smaller difference in surface tension, and specifically the difference in surface tension is preferably 30 N/m or less and more preferably 15 N/m or less.

In the method for producing the three-dimensional shaped article described above, an ink layer is formed by the ink ejected from the ink ejection head 12, and then the ink is cured by irradiating the ink layer with light. However, the method is not limited to this.

For example, the method for producing the three-dimensional shaped article may include forming plural ink layers by ejecting different inks from respective ink ejection heads 12 using plural types of inks and then curing the inks by light irradiation at one time. This method uses plural types of inks. Therefore, from the viewpoint of enhancing adhesion at the interface between the shaped articles obtained with the respective inks, the inks used for forming the adjacent ink layers preferably have a smaller difference in surface tension, and specifically the difference in surface tension is preferably 30 N/m or less and more preferably 15 N/m or less.

The three-dimensional shaping apparatus may be an apparatus to which the ink according to the exemplary embodiment can be applied, and is not limited to an apparatus having the ejection part which ejects an ink.

For example, the three-dimensional shaping apparatus according to the exemplary embodiment of the present disclosure may be a three-dimensional shaping apparatus including a housing part which houses an ink and a light irradiating part which irradiates light to cure the ink in the housing part. The ink according to the exemplary embodiment of the present disclosure is used as the ink.

Such a three-dimensional shaping apparatus is an apparatus using a method for exposing a section to which the ink housed in the housing part is output.

### <Shaped Article>

The shaped article according to the exemplary embodiment of the present disclosure contains the resin and has 5% by volume or more and 95% by volume or less of air bubbles relative to the whole volume of the shaped article and also has a region wherein at least one of the diameter and the density of air bubbles increases or decreases in the depth direction from the surface.

The ratio of the air bubbles in the shaped articles is also referred to as the “air bubble ratio”.

The diameter and the density of the air bubbles may increase or decrease stepwisely or continuously.

The shaped article according to the exemplary embodiment of the present disclosure can be preferably produced by using the ink according to the exemplary embodiment of the present disclosure described above.

As described above, the ink according to the exemplary embodiment has 5% by volume or more and 95% by volume or less of air bubbles relative to the whole volume. As described above, use of the ink having air bubbles can form the region wherein at least one of the diameter and the density of air bubbles increases or decreases in the depth direction from the surface.

The presence state of the air bubbles in the shaped article according to the exemplary embodiment of the present disclosure is described by using the drawings.

FIG. 5 is a schematic sectional view illustrating an example of the presence of air bubbles in the shaped article according to the exemplary embodiment.

As shown in FIG. 5, a shaped article MD has a region (a region X surrounded by a dotted line in FIG. 5) containing air bubbles B, and the diameter of the air bubbles B decreases in the depth direction (that is, the arrow Y direction in FIG. 5) from the surface S.

That is, in the region X of the shaped article MD, the diameter of the air bubbles B in a region near the surface S is larger than the diameter of the air bubbles B in a region away from the surface S.

The shaped article MD shown in FIG. 5 may be produced by using plural types of inks having different air bubble diameters (for example, three types of inks having different air bubble diameters), which are the ink according to the exemplary embodiment of the present disclosure, and also by using the three-dimensional shaping apparatus and method for producing a three-dimensional shaped article according to the exemplary embodiment of the present disclosure described above.

In addition, the region where the density of the air bubbles B increases or decreases along the depth direction from the surface may be formed by using plural types of inks having different air bubble ratios, which are the ink according to the exemplary embodiment of the present disclosure, and also by using the three-dimensional shaping apparatus and method for producing a three-dimensional shaped article according to the exemplary embodiment of the present disclosure described above.

The air bubble ratio in the shaped article according to the exemplary embodiment of the present disclosure may be determined according to application of the shaped article.

For example, when the shaped article according to the exemplary embodiment is caused to have a shock absorption rate of 70% or more and 95% or less, the air bubble ratio is preferably 5% or more and 95% or less, more preferably 10% or more and 95% or less, and still more preferably 15% or more and 95% or less.

Similarly, for example, when the Asker C hardness is adjusted to 10 degrees or more and 100 decrees or less, the air bubble ratio is preferably 5% or more and 95% or less, more preferably 5% or more and 90% or less, and still more preferably 10% or more and 90% or less.

The air bubble diameter in the shaped article according to the exemplary embodiment of the present disclosure may be determined according to application of the shaped article.

For example, when the shaped article according to the exemplary embodiment is caused to have a shock absorption rate of 70% or more and 95%, or less and an Asker C hardness of 10 degrees or more and 100 decrees or less, the number-average diameter of air bubbles is preferably 0.01 μm or more and 200 μm or less, more preferably 1 μm or more and 200 μm or less, and still more preferably 10 μm or less and 150 μm or less.

The air bubbles in the shaped article according to the exemplary embodiment may have either a closed cell structure or an open cell structure.

When the air bubbles have a closed cell structure, the shaped article having excellent shock absorption can be produced. In particular, when the air bubbles have a closed cell structure and when there is a region where at least one of the diameter and the density of air bubbles decreases along the depth direction from the surface, the shaped article having the region can be imparted with more excellent shock absorption.

Also, when the air bubbles have an open cell structure, the shaped article having excellent sound absorption, light transmissivity, heat absorption, etc. can be produced. In particular, when the air bubbles have an open cell structure and when there is a region where at least one of the diameter and the density of air bubbles decreases along the depth direction from the surface, the shaped article having the region can be imparted with more excellent sound absorption, light transmissivity, heat absorption, etc.

While when the shaped article according to the exemplary embodiment has a region where at least one of the diameter and the density of air bubbles increases along the depth direction from the surface, the shaped article having the region is suitable for members, for example, a packing, a sliding part, a flooring, a heat insulating material, and the like, which have shock resistance while preventing surface contamination, deterioration, deformation, and flaws.

The air bubble ratio, the number-average diameter of air bubbles, and the independent air bubble ratio are measured as follows.

That is, the shaped article is cut in the thickness direction, and the air bubble size and area are analyzed by image analysis of a sectional image by using a reflection electron microscope (SEM: SU3800, Hitachi High Technologies Corporation). The image analysis is performed by using particle size distribution measurement software MAC-VIEW (Mountech Co. Ltd.).

The air bubble ratio is determined by (total area of air bubbles in the sectional image analyzed/total area of the sectional image analyzed×100).

The number-average diameter of air bubbles is determined from the equivalent circle diameters of ten air bubbles in the sectional image analyzed.

The independent air bubble ratio is determined by (total area of independent air bubbles in the sectional image analyzed/total area of air bubbles in the sectional image analyzed×100).

The independent air bubbles in the sectional image represent the air bubbles totally surrounded by the wall surface (that is, the solid phase part of the shaping article).

When the air bubbles have an open cell structure, the air bubble diameter is measured as follows.

That is, connected air bubbles are separated into independent air bubbles in a pseudo manner based on the shape thereof, and the number-average diameter of the independent air bubbles is determined. That is, when the connected air bubbles have a shape in which two air bubbles are connected, the air bubbles are separated into two independent air bubbles in a pseudo manner, and the number-average diameter is calculated.

### [Preferred Physical Properties]

The shaped article according to the exemplary embodiment of the present disclosure has the shock absorption rate and Asker hardness C within respective preferred ranges.

With the shock absorption rate and Asker hardness C within the respective ranges described below, the shaped article being excellent in shock absorption and hardly deformed can be produced, and the shaped article is suitable for applications such as an insole, a protector that absorbs shock to a foot or knee, a supporter, and the like, which are used by adhesion to human bodies.

Also, the shaped article can be used for applications such as sporting goods such as a hand grip and the like, members for medical apparatuses, and members for healthcare apparatuses.

### (Shock Absorption Rate)

The shaped article according to the exemplary embodiment of the present disclosure preferably has a shock absorption rate of 70% or more and 95% or less and more preferably 70% or more and 93% or less.

The shock absorption rate of the shaped articles is measured as follows.

First, the shaped article is cut into a size of 50 mm×50 mm×5 mm (thickness), and a wrap is attached to the front and back surfaces in order to exclude the influence of tacking, forming a sheet-like sample.

The sheet-like sample is placed on a silicon rubber sheet (thickness: 13 mm) used as a base, and the shock absorption rate is measured by a falling-ball method.

The shock absorption rate is determined by allowing a metal ball having an outer dimeter of 17 mm to fall in a tube having an inner diameter of 55 mm from a height of 50 cm (h1) and observing a rebounding height (h2) of the iron ball from the sheet-like sample by moving image photography.

The shock absorption rate η (%) is calculated from h1 and h2 by the following formula (1).

η(%)=(h1−h2)/h1×100 Formula (1):

### (Asker Hardness C)

The shaped article according to the exemplary embodiment of the present disclosure preferably has an Asker C hardness of 10 degrees or more and 100 decrees or less, more preferably 40 degrees or more and 80 decrees or less, and still more preferably 50 degrees or more and 75 decrees or less.

The Asker harness C of the shaped article is measured as follows.

The shaped article is cut into a size of 25 mm×40 mm×3 mm (thickness), forming a measurement sample.

Then, the Asker harness C is measured by pressing a measurement needle of an Asker c-type rubber hardness meter (manufactured by Kobunshi Keiki Co., Ltd.) against the surface of the measurement sample.

### EXAMPLES

The exemplary embodiments of the present disclosure are described in detail below by examples, but the exemplary embodiments are not limited to these examples. In the description below, “parts” and “%” are on mass basis unless otherwise described.

### Examples 1 to 7 and Reference Examples 1 and 2: Preparation of Inks 1 to 9

The components described in Table 1 are mixed, and air bubbles are mixed in the resultant liquid by using an air bubble generating device (LE3FS model) of Living Energies & Co., thereby preparing each of inks 1 to 7.

The air bubble ratio and air bubble diameter are properly adjusted by the gas ejection pressure and ejection amount of the air bubble generating device and the treatment time (mixing time of air bubbles).

In addition, each of ink 8 of Reference Example 1 and ink 9 of Reference Example 2 is prepared by mixing the components described in Table 1 without using the air bubble generating device.

In Table 1, “-” represents that the corresponding compound is not contained or that the corresponding value is absent.

The air bubble ratio and air bubble diameter of each of the inks and the ink viscosity and surface tension are measured by the methods described above.

The results are shown in Table 1.

In Table 1, details of the components used in Comparative Example 1 and Example 9 are as follows.

### (Oligomer)

UA-3573AB: difunctional urethane (meth)acrylate oligomer (“UA-3573AB” manufactured by Shin-Nakamura Chemical Co., Ltd., molecular weight 2700)
UV-7000B: di- and tri-functional urethane (meth)acrylate oligomer (“UV-7000B” manufactured by The Nippon Synthetic Chemical Industry Co., Ltd., molecular weight 3500)

### (Monomer)

DCRA: dicyclopentanyl acrylate (Tokyo Chemical Industry Co., Ltd., glass transition temperature Tg: 120° C.)
IBXA: isobornyl acrylate (“IBXA”, Osaka Organic Chemical Industry Ltd., glass transition temperature Tg: 97° C.)
P2H-A: phenoxydiethylene glycol acrylate (“LIGHT ACRYLATE P2H-A” manufactured by Kyoeisha Chemical Co., Ltd., glass transition temperature Tg: −21° C.)
PO-A: phenoxyethyl acrylate (“LIGHT ACRYLATE PO-A” manufactured by Kyoeisha Chemical Co., Ltd., glass transition temperature Tg: −22° C.)
THFA: tetrahydrofurfuryl acrylate (“VISCOAT #150, THFA” Osaka Organic Chemical Industry Ltd., glass transition temperature Tg: −12° C.)

### (Other Components)

Genorad 21: polymerization inhibitor (“GENORAD 21” Rahn AG (Switzerland))
BAPO: photopolymerization initiator (“OMNIRAD 819” IGM Resins, Inc.)
EDB: oxygen scavenger (“OMNIRAD EDB ethyl (4-(dimethylamino)benzoate)”, IGM Resins, Inc.)
TEGO Rad 2011: surfactant (“TEGO (registered trademark) Rad 2011” Evonik Corp.)

### [Formation of Shaped Article]

A three-dimensional shaped article is produced by using each of the resultant inks 1 to 9 as follows.

First, the ink is poured into a container surrounded by a frame material composed of a silicone resin, and is irradiated with UV for 5 minutes by using a high-pressure mercury lamp with an output 1500 W to form a sheet-like shaped article of 50 mm×50 mm×5 mm (thickness) as a sheet-like evaluation sample.

### [Measurement and Evaluation]

### (Measurement of Shock Absorption Rate and Asker Hardness C)

The shock absorption rate and Asker hardness C of the resultant sheet-like evaluation sample are measured by the respective methods described above. The results are show in Table 1.

### (Confirmation of State of Air Bubbles)

It is confirmed whether air bubbles in the resultant sheet-like evaluation sample have a closed cell structure or an open cell structure by the method described above. The results are shown in Table 1.

### (Productivity of Shaped Article)

In forming the sheet-like evaluation sample (shaped article) as described above, the sample not requiring cutting for forming the intended shape (the sheet shape of 50 mm×50 mm×5 mm) is evaluated as “A”, and the sample requiring cutting is evaluated as “B”. The results are shown in Table 1.

(Shape Stability with Time)

The resultant sheet-like evaluation sample is stored for 20 days in an environment of 50° C. and 90%., and then the shape after storage is visually observed. The results are shown in Table 1.

It is determined whether or not the shape is changed before and after storage, and evaluation is made according to the following criteria.

A: No change is observed in the shape before and after storage.

B: Change in shape is partially observed before and after storage.

TABLE 1

| | | | | | | | | | Refer- | Refer- |
|---|---|---|---|---|---|---|---|---|---|---|
| | | | | | | | | | ence | ence |
| | | Exam- | Exam- | Exam- | Exam- | Exam- | Exam- | Exam- | Exam- | Exam- |
| | | ple 1 | ple 2 | ple 3 | ple 4 | ple 5 | ple 6 | ple 7 | ple 1 | ple 2 |
| Ink No. | | 1 | 2 | 3 | 4 | 5 | 6 | 7 | 8 | 9 |
| Difunctional | UA-3573AB | 8 | 8 | 7 | 7 | 7 | — | — | 8 | 7 |
| oligomer | UV-7000B | — | — | — | — | — | 10 | 10 | — | — |
| [% by mass] | | | | | | | | | | |
| Monofunctional | DCPA(Tg = 120° C.) | 42 | 42 | 43 | 43 | 43 | 60 | 60 | 52 | 43 |
| monomer A | IBXA(Tg = 97° C.) | — | — | — | — | — | — | — | — | — |
| [% by mass] | | | | | | | | | | |
| Monofunctional | P2H—A(Tg = −21° C.) | 46 | 46 | 46 | 46 | 46 | — | — | 36 | 46 |
| monomer B | PO—A(Tg = −22° C.) | — | — | — | — | — | — | — | — | — |
| [% by mass] | THFA(Tg = −12° C.) | — | — | — | — | — | 26 | 26 | — | — |
| Other | GENORAD 21 | 0.4 | 0.4 | 0.4 | 0.4 | 0.4 | 0.4 | 0.4 | 0.4 | 0.4 |
| component | BAPO | 3 | 3 | 3 | 3 | 3 | 3 | 3 | 3 | 3 |
| | EDB | 0.5 | 0.5 | 0.5 | 0.5 | 0.5 | 0.5 | 0.5 | 0.5 | 0.5 |
| | TEGO RAD 2011 | 0.1 | 0.1 | 0.1 | 0.1 | 0.1 | 0.1 | 0.1 | 0.1 | 0.1 |
| Total amount [% by mass] | | 100 | 100 | 100 | 100 | 100 | 100 | 100 | 100 | 100 |
| Condition 1 | Ratio of W_{A} + W_{B} + W_{C} | 96 | 96 | 96 | 96 | 96 | 96 | 96 | 96 | 96 |
| | [% by mass] | | | | | | | | | |
| Condition 2 | W_{c}/(W_{A} + W_{B} + W_{c}) × 100 | 8.3 | 8.3 | 7.3 | 7.3 | 7.3 | 10.4 | 10.4 | 8.3 | 7.3 |
| | [% by mass] | | | | | | | | | |
| Condition 3 | Tg_{A} − Tg_{B} [° C.] | 141.0 | 141.0 | 141.0 | 141.0 | 141.0 | 132.0 | 132.0 | 141.0 | 141.0 |
| Condition 4 | (Tg_{A} × W_{A})/(W_{A} + W_{B}) + | 46.3 | 46.3 | 47.1 | 47.1 | 47.1 | 80.1 | 80.1 | 62.3 | 47.1 |
| | (Tg_{B} × W_{B})/(W_{A} + W_{B}) [° C.] | | | | | | | | | |
| Condition 5 | W_{A}/(W_{A} + W_{B} + W_{c}) × 100 | 43.8 | 43.8 | 44.8 | 44.8 | 44.8 | 62.5 | 62.5 | 54.2 | 44.8 |
| | [% by mass] | | | | | | | | | |
| Condition 6 | W_{B}/(W_{A} + W_{B} + W_{c}) × 100 | 47.9 | 47.9 | 47.9 | 47.9 | 47.9 | 27.1 | 27.1 | 37.5 | 47.9 |
| | [% by mass] | | | | | | | | | |
| Condition 7 | W_{A}:W_{B} | 42:46 | 42:46 | 43:46 | 43:46 | 43:46 | 60:26 | 60:26 | 42:46 | 43:46 |
| Air bubble | Air bubble ratio [%] | 19 | 20 | 21 | 21 | 22 | 40 | 20 | 0 | 0 |
| | Number-average diameter | 20.3 | 20.3 | 20 | 70 | 120 | 1.3 | 1.3 | — | — |
| | of air bubble [μm] | | | | | | | | | |
| | Type of gas | Air | Nitrogen | Nitrogen | Nitrogen | Nitrogen | Air | Nitrogen | — | — |
| Physical | Viscosity at 25° C. [mPa · s] | 21 | 21 | 18 | 18 | 18 | 25 | 24 | 20 | 18 |
| properties | Surface tension [mN/m] | 20 | 20 | 20 | 20 | 20 | 18 | 18 | 21 | 19 |
| Evaluation | Shock absorption rate η [%] | 80 | 80 | 88 | 92 | 90 | 92 | 77 | 76 | 80 |
| | Asker C hardness [degree] | 67 | 67 | 43 | 39 | 55 | 39 | 70 | 80 | 63 |
| | Cell structure | Closed | Closed | Closed | Closed | Closed | Closed | Closed | — | — |
| | Productivity of shaped article | A | A | A | A | A | A | A | A | A |
| | Shape stability with time | B | A | A | A | A | B | A | — | — |

### Comparative Example 1: Preparation of Composition C1

Composition C1 is prepared by mixing the following components.
UA-3573AB: 3.7 parts by mass
DCPA: 40 parts by mass
P2H-A: 50 parts by mass
Foaming agent: ADVANCELL EML 101 (expansion starting temperature: 115° C.-130° C., Sekisui Chemical Co., Ltd.): 1 part by mass
GENORAD 21: 0.4 parts by mass
BAPO: 3 parts by mass
TEGO RAD2011: 1.8 parts by mass
EDB: 0.1 parts by mass

The composition C1 has a viscosity at 25° C. of 25 mPa·s and a surface tension of 23 mN/m.

### [Formation of Shaped Article]

A three-dimensional shaped article is produced by using the composition C1 as follows.

The ink is poured into a container surrounded by a frame material (a square frame with an inner diameter 50 mm by 50 mm) composed of a silicone resin, and is irradiated with UV for 10 minutes by using a high-pressure mercury lamp with an output 1500 W to form a shaped article. The shaped article cooled after UV irradiation is expanded by the foaming agent, and thus cutting is required for adjusting the thickness to 5 mm.

Thus, the productivity of the shaped article of Comparative Example 1 described above is evaluated as “B”.

### Example 8

A sheet-like shaped article in which the air bubble diameter decreases along the depth direction from the surface as shown in FIG. 5 is formed by using the inks 3 to 5 and 9.

Specifically, a dispenser-type 5-axis coating device (SSI Japan Co., Ltd.) and INTEGRATION TECHNOLOGY LTD., Subzero-055 (strength: 100 w/cm) selected as an UV irradiation light source are provided on a three-dimensional shaping apparatus including a drive part and a control part, producing a shaping apparatus for test.

The shaping apparatus forms an ink layer having a thickness of 500 μm at each time of scanning. First, layers of the ink 9 are laminated to a thickness of 1000 μm, then layers of the ink 3 are laminated to a thickness of 1000 μm, then layers of the ink 4 are laminated to a thickness of 1000 μm, and then layers of the ink 5 are laminated to a thickness of 1000 μm. Then, the resultant laminate is cured by ultraviolet irradiation to produce a three-dimensional shaped article.

In addition, the shaping apparatus has a structure in which under light shielding conditions, each of the inks is passed through Profile Star A050 Filter (filter precision 5 μm) manufactured by Nihon Pall Ltd. from a storage tank by using a feed pump through Tygon 2375 chemical resistant tube manufactured by Saint-Gobain K. K. to remove foreign materials, and is then fed to an inkjet head.

By using the three-dimensional shaping apparatus, a sheet-like shaped article of 15 mm×15 mm×4 mm (thickness) is produced.

The resultant sheet-like shaped article has 5% by volume or more and 95% by volume or less of air bubbles relative to the total volume of the shaped article and also has a region where the air bubble diameter decreases along the depth direction from the surface (the surface of the layers of the ink 5). Specifically, the resultant sheet-like shaped article has a region where the number-average diameter of air bubbles in the layers of the ink 5 is 120 μm, the number-average diameter of air bubbles in the layers of the ink 4 is 70 μm, and the number-average diameter of air bubbles in the layers of the ink 3 is 20 μm, and thus the air bubble diameter decreases along the depth direction from the surface of the layers of the ink 5.

The shock absorption rate and Asker hardness C of the resultant sheet-like shaped article are measured by the same methods as in Example 1. As a result, the shock absorption rate is 90%, and the Asker hardness C is 63 decrees.

In addition, it is confirmed whether the air bubbles in the resultant sheet-like shaped article have a closed cell structure or an open cell structure by the method described above. As a result, it is found that the air bubbles have a closed cell structure.

### Example 9

A liquid is prepared by mixing the following components.
UA-3573AB: 3.7 parts by mass
DCPA: 41 parts by mass
P2H-A: 50 parts by mass
GENORAD 21: 0.4 parts by mass
BAPO: 3 parts by mass
TEGO RAD 2011: 1.8 parts by mass
EDB: 0.1 parts by mass

Each of inks 10-1 and 10-2 is prepared by mixing air bubbles in the resultant liquid by using an apparatus and conditions described below.

### —Apparatus and Conditions—

Apparatus: Tech Co., Ltd., high-speed mini-kit (KH-125) using a SPG membrane
Apparatus conditions for ink 10-1: external pressure system, SPG membrane (pore diameter 50 μm), nitrogen gas pressure 0.3 mPa
Apparatus conditions for ink 10-2: external pressure system, SPG membrane (pore diameter: 10 μm), nitrogen gas pressure 0.15 mPa
Pump feed amount: 0.1 L/min
Amount of liquid: 200 g
Circulation time: 10 min

Any one of the inks 10-1 and 10-2 has a viscosity at 25° C. of 25 mPa·s and a surface tension of 23 mN/m.

The resultant ink 10-1 has an air bubble ratio of 70% and an air bubble number-average diameter of 140 μm. The resultant ink 10-2 has an air bubble ratio of 705 and an air bubble number-average diameter of 40 μm.

A central portion of a silicone rubber sheet of 110 mm×110 mm×5 mm (thickness) is hollowed out in a square form of 50 mm×50 mm, forming a mold.

The mold is placed on a lower sheet of 120 mm×120 mm×5 mm (thickness), then the ink 10-2 is added up to a half amount of the mold, then immediately the ink 10-1 is added up to a half amount of the mold, and then allowed to stand for 5 minutes. Then, an upper cover sheet of 120 mm×120 mm×1 mm (thickness) and a glass plate of 120 mm×120 mm×5 mm (thickness) as an uppermost cover are placed in this order on the mold to which the inks 10-1 and 10-2 have been added, allowed to stand for 90 seconds, and then irradiated with UV for 5 minutes from a high-pressure mercury lamp with an output of 1500 W from the glass plate side. Then, the glass plate as the uppermost cover is left as it is, while the mold held between the upper cover sheet and the lower cover sheet is reversed and then irradiated with UV for 5 minutes from a high-pressure mercury lamp with an output of 1500 W from the glass plate side.

Then, the mold held between the upper cover sheet and the lower cover sheet is again reversed and then irradiated with UV for 3 minutes from a high-pressure mercury lamp with an output of 1500 W from the glass plate side. Then, the mold held between the upper cover sheet and the lower cover sheet is again reversed and then irradiated with UV for 3 minutes from a high-pressure mercury lamp with an output of 1500 W from the glass plate side.

Then, the mold is allowed to stand at room temperature, and the resultant shaped article is removed from the mold.

As described above, a sheet-like shaped article of 15 mm×15 mm×5 mm (thickness) is produced.

The resultant sheet-like shaped article has an overall air bubble ratio of 70%, and the air bubbles in the layer of the ink 10-1 have a number-average diameter of 140 μm, and the air bubbles in the layer of the ink 10-2 have a number-average diameter of 40 μm. Thus, the sheet-like shaped article has a region where the air bubble diameter decreases along the depth direction from the surface of the layer of the ink 10-1.

The shock absorption rate and Asker hardness C of the resultant sheet-like shaped article are measured by the same methods as in Example 1. As a result, the shock absorption rate is 95%, and the Asker hardness C is 50 decrees.

In addition, it is confirmed whether the air bubbles in the resultant sheet-like shaped article have a closed cell structure or an open cell structure by the method described above. As a result, it is found that the air bubbles have an open cell structure.

### (Sound Absorption of Shaped Article)

The sound absorption coefficient of the resultant shaped article is measured by a tube method using vertical incident sound absorption coefficient measuring apparatus.

Specifically, first the resultant shaped article adjusted by cutting according to the diameter of a sample holder of an apparatus below.

Also, the sound absorption coefficient of the sheet-like shaped article including the layer of the ink 10-1 and the layer of the ink 10-2 is measured from the ink 10-1 layer side.

The vertical incident sound absorption coefficient at a frequency of 100 Hz to 6000 Hz is measured according to JIS A 1405-2.
Apparatus: Vertical incident sound absorption measuring system SR-4100 (Ono Sokki Co., Ltd.)
Conditions: Impedance tube A (length: 835 mm, inner diameter: 100 ϕ: measurement frequency: 50 Hz to 1.6 kHz
Impedance tube B (length: 500 mm, inner diameter: 29 ϕ): measurement frequency: 500 Hz to 6.4 kHz

The sheet-like shaped article including the layer of the ink 10-1 and the layer of the ink 10-2 has a sound absorption coefficient of 0.25 or more at 500 Hz, a sound absorption coefficient of 0.3 or more at 1200 Hz, and a sound absorption coefficient of 0.3 or more at 6000 Hz, and thus is evaluated to have excellent sound absorption.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An ink for producing a shaped article, comprising:
a photopolymerizable compound; and
5% by volume to 95% by volume of air bubbles relative to the total volume of the ink.

2. The ink for producing a shaped article according to claim 1, wherein a number-average diameter of the air bubbles is within a range of 0.01 μm to 200 μm.

3. The ink for producing a shaped article according to claim 1, wherein a number-average diameter of the air bubbles is within a range of 1 μm to 200 μm.

4. The ink for producing a shaped article according to claim 1, wherein the viscosity at 25° C. of the ink for producing a shaped article is within a range of 1 mPa·s to 10,000 mPa·s

5. The ink for producing a shaped article according to claim 1, wherein a viscosity at 25° C. of the ink for producing a shaped article is within a range of 10 mPa·s to 1,000 mPa·s

6. The ink for producing a shaped article according to claim 1, wherein the air bubbles contain inert gas.

7. A three-dimensional shaping apparatus comprising:
an injection part that contains the ink for producing a shaped article according to claim 1 and injects the ink; and
a light irradiating part that irradiates the ejected ink with light to cure the ink.

8. A three-dimensional shaped article comprising:
a resin;
5% by volume or more and 95% by volume or less of air bubbles relative to a total volume of the shaped article; and
a region where at least one of a diameter and a density of the air bubbles increases or decreases along a depth direction from the surface.

9. The three-dimensional shaped article according to claim 8, wherein a number-average diameter of the air bubbles is within a range of 0.01 μm to 200 μm.

10. The three-dimensional shaped article according to claim 8, wherein the air bubbles in the region have a closed cell structure or an open cell structure.

11. The three-dimensional shaped article according to claim 8, wherein a shock absorption rate is within a range of 70% to 95%.

12. The three-dimensional shaped article according to claim 8, wherein an Asker C hardness is within a range of 10 degrees to 100 degrees.
